(19) United States
(12) Patent Application Publication
(10) Pub. No.: US 2004/0217760 A1
(43) Pub. Date: Nov. 4, 2004

(54) Bayesian methods for flow parameter estimates in magnetic resonance imaging

(76) Inventors: Frank L. Madarasz, Madison, AL (US); Ramarao Inguva, Huntsville, AL (US)

Correspondence Address: MATHEWS, COLLINS, SHEPHERD & GOULD, PA, 100 THANET CR, SUITE 306, PRINCETON, NJ, 08540, US

(21) Appl. No.: 09/781,035

(22) Filed: Feb. 9, 2001

Related U.S. Application Data
(60) Provisional application No. 60/181,823, filed on Feb. 11, 2000.

(51) Int. Cl. G01V 3/00

(52) U.S. Cl. 324/307; 324/309

(57) ABSTRACT

A method for flow parameter estimates magnetic resonance imaging comprising the following steps: accessing magnetic resonance imaging data; inputting a magnetic resonance imaging model function; and, using conditional probabilities based on Bayes' Theorem.

### CROSS REFERENCES TO RELATED APPLICATIONS

This application claims the benefit of U.S. Provisional Application Ser. No. 60/181,823 filed on Feb. 11, 2000.

### FIELD OF THE INVENTION

This invention relates to the field of signal processing, and more particularly to magnetic resonance imaging systems.

### BACKGROUND OF THE INVENTION

Magnetic Resonance Imaging (MRI) has proven to be a revolutionary diagnostic radiological tool, due to its high spatial resolution and excellent discrimination of soft tissues. Magnetic Resonance Imaging provides rich information about anatomical structure, enabling quantitative anatomical studies of diseases, the derivation of computerized anatomical atlases, as well as three-dimensional visualization of internal anatomy, for use in pre-operative and intra-operative visualization, and in the guidance of therapeutic intervention.

The role of dynamic imaging in medicine is of growing importance as a tool for both diagnosis and research. Most importantly is the role of flow studies inside the vascular tree: these range from flow studies in the heart, major arteries, and through replacement devices like valves, to more delicate studies of flow patterns in the brain.

For very large superficial vessels like the carotid, methods such as Doppler have proved very useful. Flow studies of smaller, deeper vessels have necessitated more complicated and invasive techniques such as the scanning of exogenously introduced radio labeled substances. Valuable as these techniques have been, the results have lacked resolution to provide detailed flow parameters on a small scale.

Therefore, there is a need to be able to provide higher resolution and detail flow parameters for smaller/deeper vessels.

### SUMMARY OF THE INVENTION

In accordance with the present invention, there is provided a method and system for flow parameter estimates in magnetic resonance imaging comprising the following steps: accessing magnetic resonance imaging data; inputting a magnetic resonance imaging model function; and, using conditional probabilities based on Bayes' Theorem.

### BRIEF DESCRIPTION OF THE DRAWINGS

A more complete understanding of the present invention may be obtained from consideration of the following description in conjunction with the drawings in which:

FIG. 1 is an overview of a Magnetic Resonance Imaging system; and,

FIG. 2 is a high level flow chart of the system methodology.

### DETAILED DESCRIPTION OF VARIOUS ILLUSTRATIVE EMBODIMENTS

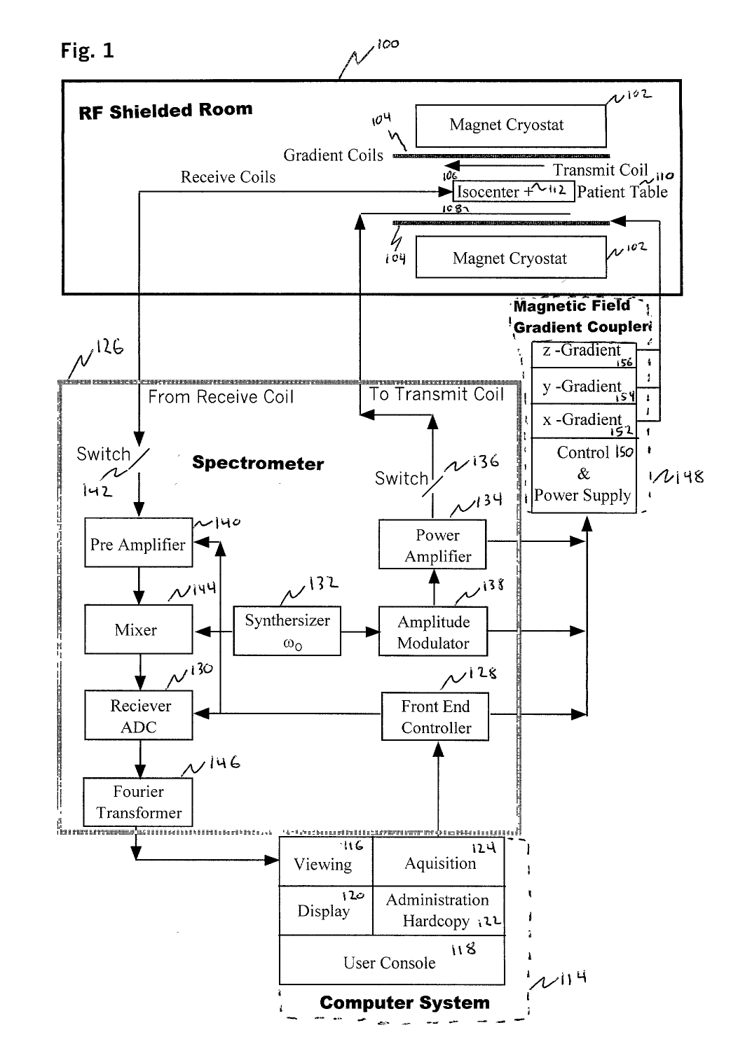

A conventional Magnetic Resonance Imaging system is generally depicted in FIG. 1. The MRI machine is placed in an RF shielded room 100 where data on the patient will be taken. This is to avoid spurious signals from the surroundings: both from external electronics as well as from signals generated by the driving electronics of the system itself. The probe part of the MRI machine houses magnetic cryostats 102 for keeping the magnetic coils cool and in a peak operating range. There are essentially three sets of coils: gradient coils 104, receive coils 106 and transmit coils 108. The patient is positioned on a patient table 110, which brings the patient into the magnetic field in such a way that the anatomy to be imaged is in the region where the field is homogeneous; this region is called the isocenter 112.

A computer system 114, located outside the RF shielded room 100, operates the MRI machine. A user requesting specific imaging information via acquisition commands mans the computer system 114. The processed data is sent to the viewing section 116 on the console 118. Here the user can display the images on the monitor 120 and/or can reproduce them on a hard copy camera 122.

To do a targeted scan relevant patient statistics are first entered into the administration section on the console 118. The system is then instructed to do the required scan, including the geometrical parameters, the imaging method, and the sequence timing. (For new or experimental imaging the gradient field strength as a function of time for each direction x, y and z and the RF waveform must first be programmed into the memory of the computer system 114. This can also be done on the console 118.) The information is then forwarded to an operational area of the machine known in general as the “spectrometer.” The spectrometer 126 consists of the front-end-controller 128 (controlling the magnet, gradients, RF transmitter and receiver, RF coil switches, etc.) and the data acquisition around the receiver (the receiver switches and the ADC (analog-to-digital converter) 130.

Before the actual scan begins the spectrometer must perform an initialization sequence: tune the synthesizer 132 frequency, ωₒ, to the gyromagnetic frequency; tune the RF receiving coils; and, the RF power and receiver gain must be adjusted to the specs of the designated measurement, etc.

Now the Spin Echo sequence can start. All components, except for the magnet, turned off a selection of the field gradient is. When the field gradient reaches it preset required value the RF power amplifier 134 is engaged and its output is switched 136 with frequency ωₒ. This signal (also known as the excitation pulse signal) is modulated in the waveform generator 138 and fed into the power amplifier 134. The RF signal, which can be AM or FM modulated, drives a current in the transmit coil 108 to produce the required magnetic induction, B_{RF}, within the center of the coil. Simultaneously, the receiver coils 106 are detuned and the pre-amplifier 140 blocked by switch 142 so that the large transmit signal will not burn out the pre-amplifier 140. When the RF pulse is of sufficient magnitude, the output line of the power amplifier 134 is switched 136 to the matched load again. The output noise of the power amplifier 134 with zero input signal is high enough that it could mask the MR signal to be measured and so the switching is a necessary function. The selection gradient is now switched off. Because of the high coil inductance and the gradient-amplifier voltage the reduction of the gradient field is not instantaneous but occurs at some small time interval. As a result of this procedure, spins in a thin slice of the target are aligned.

Next, the dephasing gradient and the phase-encode gradient are switched on and brought to the required strength, which has been programmed into the operational specs of the spectrometer 126. When the gradient pulses have the required surface value, i.e., the integral of the gradient over time, they are switched off and the refocusing pulse can now be applied. This 180° RF pulse is usually slice selective and can be applied to the same slice as the excitation RF pulse. Its waveform is similar to that of the excitation pulse but with twice the amplitude or four times the power. In single-slice methods, slice selectivity of the refocusing pulse may be left out, making the pulse of shorter duration possible.

When the refocusing RF pulse cycle is finished the read-out gradient is switched on. During this gradient pulse the receiver coil 106 is in a tuned state and the receiver is activated. Concurrently, the magnetization is measured and the ADC 130 samples the received signal in predetermined sampling time interval. The system is then allowed a period of time to relax to its initial configuration so that the spectrometer 126 can proceed to image the next elemental slice in the scan sequence. The process is repeated until the whole scan is completed. Slice sample data are sent to the array processor 146 where fast Fourier transforms are performed on the data. When the slices are transformed and reassembled, an image results. This image is sent to the view section 116 on the console 118.

Usually after this first scan more scans of the same anatomical area follow. These scans are taken of slices positioned on the basis of the first image. The user can select the orientation and the off-center distance of the slices addressed in such scans.

The present invention, Bayesian methods for flow parameter estimates magnetic resonance imaging is a technique and system, wherein information collected in Nuclear Magnetic Resonance (NMR), also known as Magnetic Resonance Imaging (MRI), studies provides provide higher resolution and detail. The present invention resolves problems of resolution and deep tissue location, thus enabling the use of a non-invasive technique for virtually all flow studies on any scale available to MRI.

The immediate clinical implications are widespread. In the assessment of adequate blood flow, such as the determination of cardiac output, flow to the extremities or the head, the present invention provides a degree of accuracy and penetration to non-superficial vessels unavailable until now. This is especially useful in the evaluation of the extent of thrombotic/embolic strokes and myocardial infarctions, both past and in evolution by use of a non-invasive, zero radiation dose, real time procedure.

In addition to answering the “What is the flow in this vessel?” question, the present invention, Bayesian methods for flow parameter, estimates magnetic resonance imaging, enables the examination of microscopic flow characteristics on an extremely small scale. This allows the examination of flow parameter gradients across a vessel diameter and the quantitative determination of turbulence regimes across hydrodynamic impedances such as heart valves, plaques, spasms, and malformations such as anneyurisms. This latter capability is very important in the design of intravascular prostheses such as valves, vessel replacements, stents, etc.

Nuclear Magnetic Resonance (NMR) is fundamentally a process by which the magnetic moments of various nuclei are obtained. The nuclei are first immersed in a fairly strong but homogenous magnetic field. This field causes the nuclear magnetic moment of an nucleus to precess about an axis parallel to the direction of the field. The frequency with which the magnetic moment precesses is called the Larmor frequency. Then, a weak oscillating field is applied in an orthogonal direction to the homogenous field. When the frequency of the field oscillations is the Larmor frequency, a resonance condition is met and the nuclei are caused to jump from one quantum state to another.

All magnetic resonance experiments involve the transition of the nuclear spins from a given state to one of higher energy. In order to be detectable, two conditions must be satisfied. First, more nuclei must be in the lower states than in the upper ones, so that the upward absorptive transitions outnumber the downward induced emissive transitions which return energy to the oscillator. Second, the nuclei in the upper state must have a means of returning to a lower state other than by emitting radiation. The first condition is satisfied when the populations of the various energy states are in statistical equilibrium at sufficiently low temperatures in a sufficiently strong magnetic field. The second condition is satisfied if there is a sufficiently strong coupling between the nuclear moment and the solid or liquid system in which it is situated. This coupling leads to nonradiative transitions of the nuclei, the energy being transferred to the crystal lattice where it appears as heat. This energy transfer called spin-lattice relaxation permits nuclear spins to return toward statistical equilibrium. Another relaxation mechanism is called spin-spin relaxation. It is due to the interaction between the magnetic moments of two nuclei. The effect of the spin-spin interaction is to cause the transverse component—orthogonal to the homogeneous magnetic induction field—of the magnetization to relax back to zero.

The phenomenon of nuclear magnetic resonance has been put to use as a powerful tool for discovering new properties of matter. This has been especially true in nuclear physics, chemistry, and most recently in medicine where NMR is called MRI. Numerical values of the magnetic moments provide information about the structure of the nuclei.

It is critical to be able to extract and discern all relevant structural information from the NMR data in order to have a true and accurate picture of the system of interest. Brethorst developed a Bayesian method, based on conditional probabilities, for inverting nuclear magnetic resonance measurements-free magnetic induction decay measurements taken on a mixture of 63% liquid Hydrogen-Deuterium (HD) and Deuterium (D₂) at 20.2 K—to obtain critical characterization parameters of a target molecular specie. His approach used a Gaussian-like Likelihood Function which employed a simple single harmonic frequency Model Function and the assumption of background white noise. He then modified the Likelihood Function to include multiple harmonic frequencies, assumed not to have any interfering effects within the sample, which resulted in a somewhat standard Posterior Probability Function known as the Student-t Distribution. The Bretthorst method accurately estimated quantities such as spin precession frequencies, spin decay/relaxation rates, and spin magnetization. His results were markedly better than those obtained by stochastic methods. Additionally, the Bretthorst method has the ability to resolve very closely spaced frequencies if there is information (evidence) in the data. This fine structure is of particular importance in flow studies.

The use of the Bayesian method has enhanced the information provided by NMR free magnetic induction decay measurements on stationary systems. However, it has not been modified and applied to dynamic systems or in vivo measurements on patients where motion—intentional as well as unintentional—and other than white background noise are critical. The present invention, Bayesian methods for flow parameter estimates in magnetic resonance imaging, is a technique and system which applies Bayesian techniques to the analysis of complex MRI flow data to obtain parameters of interest such as velocity, acceleration, turbulence, and phase shifts due to flow gradients. This is done, in part, by uniquely integrating dynamic Model Functions into the Bayesian scheme. (Dynamic Model Functions mean parameterized Model Functions that are time-dependent in order to specifically address the flow nature of the problem.) MRI flow data, in particular in vivo flow data, is infinitely more difficult to resolve than in vivo stationary data. The present invention's creative application of Bayesian probability methods to in vivo flow data is of extreme benefit in resolving this vastly more complex information.

### The Bloch Equations

If a spin magnet moment m is immersed in a field of magnetic induction B the resulting torque on the system is the time derivative of the spin angular momentum L and is given by

$$\frac{ⅆ L}{ⅆ t} = m \times B , \qquad ( 2.1 )$$

Since m=g(e/2 mₚc)L=γ_{N}L, then

$$\frac{ⅆ m}{ⅆ t} = {γ}_{N} ( m \times B ) . \qquad ( 2.2 )$$

g is the nuclear g-factor whose value depends on the particular nucleus being studied, e is the charge of an electron, mₚ is the rest mass of the spin particle (in the present case, a nucleon—the proton/neutron) and c is the speed of light in vacuum. One of the consequences of having the magnetic moment proportional to the angular momentum is that when placed in a magnetic field it will precess. Indeed, the magnetic moment precesses with a frequency that is dependent upon the g-factor or the structure of the nucleus.

Equation (2.2) can easily be generalized to a system of N nucleons. In this case the torque is given by the time derivative of the net magnetic moment. For systems consisting of multiple magnetic moments due to individual sources, it is conventional to work with the magnetization M, which is the net magnetic moment per unit volume.

$$\frac{ⅆ M}{ⅆ t} = {γ}_{N} ( M \times B ) . \qquad ( 2.3 )$$

Bloch modified Eq. (2.3) in a phenomenological approach to include spin relaxation of a crystalline solid-state system in two ways. First, he included the interactions between all spin magnetic moments of the nucleons—the so-called spin-spin interactions. And second, he included the relaxation mechanism due to spin-lattice interactions. The resulting Bloch equation(s) is

$$\frac{ⅆ M}{ⅆ t} = {γ}_{N} ( M \times B ) - \frac{{M}_{x} i + {M}_{y} j}{{T}_{2}} - \frac{( {M}_{z} - {M}_{o} )}{{T}_{1}} k . \qquad ( 2.4 )$$

Here Mₓ, M_{y} and M_{z} are the Cartesian components of M, i, j and k are their respective unit vectors and Mₒ is the equilibrium value of M_{z}, T₂ is the spin-spin relaxation time, and T₁ corresponds to the spin-lattice relaxation time.

Casting the above in terms of a typical MRI test, the homogenous constant magnetic induction field is chosen to be oriented along the positive z-axis, Bₒ=B₆₀k, of the laboratory frame. To this is added an oscillating—rotating—field term having components in the x-y plane, B₁=B₁ₓi+B_{1y}j, i.e. orthogonal to Bₒ. This term represents the excitation of the system by an RF pulse and will impose its own precession on the magnetization. Finally, a term is added which is called the gradient field term. This term has components[,] which account for two different mechanisms. The excitation pulse that gives rise to B₁ is not localized. In MRI measurements, excitation of the spins in a selected slice of sample is required. This is accomplished by the superposition of a small linear position-dependent field onto the homogeneous field. Ideally this would be directed along the z-axis parallel to Bₒ. Additional components are needed, however, that will account for all the unwanted field deviations. Both of these mechanisms can be combined in one term and written as G·r, where G is obviously the gradient of the net field and r is a coordinate point in the sample of a particular nucleus. In general, especially in a flow system, G and r will vary with time. In addition, there are statistical fluctuations throughout the system due to a myriad of phenomena.

B=Bₒ+B₁+[G(r, t)·r(t)]k (2.5)

The precession frequency is proportional to the magnitude of the homogeneous magnetic induction Bₒ.

ωₚ=γ_{N}|Bₒ|=γ_{N}Bₒ (2.6)

This simple relationship is the basis for a convenient technique, which is fruitful in obtaining essential MRI data. The technique is to transform the observations from the laboratory reference frame into a rotating reference frame that rotates in such a way as to view the magnetization, M, as stationary. This is accomplished by constructing a rotating coordinate system (sometimes referred to as the body system and is usually denoted with primes on all coordinates to distinguish it from the lab frame) whose z′-axis is aligned with Bₒ and whose x′-y′ plane rotates with the precession frequency ωp. It is as though Bₒ has no effect on the magnetization. The advantage of observation from the perspective of the rotating system is that now all the necessary information needed to form an image is contained in the motion of the x′, y′ coordinates of the magnetization. That is the motion that will be caused by deviations from Bₒ as a result of “extra” gradient fields—unwanted deviations, which produce image artifacts.

In the body frame only the precession of M due to B₁ and the gradient term, G·r, will be observed. B₁ will cause M to precess with frequency ω₁=γ_{N}B₁ about the x′-axis in the y′z′plane. Thus in the rotating system the Bloch equation takes the form,

$${( \frac{ⅆ M}{ⅆ t} )}_{rot} = {γ}_{N} ( M \times {B}_{eff} ) - \frac{{M}_{{x}^{′}} {i}^{′} + {M}_{{y}^{′}} {j}^{′}}{{T}_{2}} - \frac{( {M}_{{z}^{′}} - {M}_{o} )}{{T}_{1}} {k}^{′} \qquad ( 2.7 )$$

where k=k′, and

M=M_{x′}i′+M_{y′}j′+M_{z′}k′, (2.8)

B_{eff}=B_{1x′}i′+B_{1y′}j′+[G·r]k′. (2.9)

Note that G·r is a scalar invariant.

Since the intent is to work completely in the body system, all primes can be dropped—the rotating reference frame is implied. The Bloch equation and its component equations can now be written as

$$\begin{matrix}\frac{ⅆ M}{ⅆ t} = {γ}_{N} ( M \times {B}_{eff} ) - \frac{{M}_{x} i + {M}_{y} j}{{T}_{2}} - \frac{( {M}_{z} - {M}_{o} )}{{T}_{1}} k , & ( 2.10 ) \\ \frac{ⅆ {M}_{x}}{ⅆ t} = - \frac{{M}_{x}}{{T}_{2}} + {γ}_{N} [ G ( r , t ) \cdot r ( t ) ] {M}_{y} - {γ}_{N} {B}_{1 y} {M}_{z} , & ( 2.11 ) \\ \frac{ⅆ {M}_{y}}{ⅆ t} = - {γ}_{N} [ G ( r , t ) \cdot r ( t ) ] {M}_{x} - \frac{{M}_{y}}{{T}_{2}} + {γ}_{N} {B}_{1 x} {M}_{z} , & ( 2.12 ) \\ \frac{ⅆ {M}_{z}}{ⅆ t} = {γ}_{N} ( {B}_{1 y} {M}_{x} - {B}_{1 x} {M}_{y} ) - \frac{( {M}_{z} - {M}_{o} )}{{T}_{1}} . & ( 2.13 )\end{matrix}$$

This whole set of equations can be conveniently handled in matrix form. Defining two column vectors, |M) and |B),

$$\begin{matrix}\vert M ⟩ = [ \begin{matrix}{M}_{x} \\ {M}_{y} \\ {M}_{z}\end{matrix} ] , & ( 2.14 ) \\ \vert B ⟩ = [ \begin{matrix}0 \\ 0 \\ {M}_{o} / {T}_{1}\end{matrix} ] , & ( 2.15 )\end{matrix}$$

and the square matrix A

$$A = [ \begin{matrix}- 1 / {T}_{2} & {γ}_{N} ( G \cdot r ) & - {γ}_{N} {B}_{1 y} \\ - {γ}_{N} ( G \cdot r ) & - 1 / {T}_{2} & {γ}_{N} {B}_{1 x} \\ {γ}_{N} {B}_{1 y} & - {γ}_{N} {B}_{1 x} & - 1 / {T}_{1}\end{matrix} ] \qquad ( 2.16 )$$

results in the compact matrix equation,

$$\frac{ⅆ \vert M ⟩}{ⅆ t} = A \vert M ⟩ + \vert B ⟩ \qquad ( 2.17 )$$

This equation is the theoretical basis for most MRI measurements including measuring sequences of RF pulse measurements.

### MRI Imaging Equations With Flow

Whether it is patient movement, cardiac pulsing, or blood flow, motion of the target will cause inconsistencies in the phase and amplitude information obtained from measurements of the transverse magnetization, which can lead to image blurring and ghosts. It is possible to minimize the uncertainties in the data if the mechanisms that are producing them are known. However, in the case of blood flow, the flow properties themselves can be studied by visualizing the flow paths of arteries and veins (MR angiography) or by measuring the velocity of the fluid using direct flow measurements. There are essentially two approaches used for flow imaging. The first is called the phase-contrast method. It depends on the phase difference of the transverse magnetization of the flowing blood with respect to the stationary tissue surrounding the fluid. The second is called the modulus contrast method. This method is based on the difference of magnitudes of the transverse magnetization of the blood flow and the stationary tissue.

Typical MRI systems involve echo-planar imaging: that is, a detection of spin echoes in planes or slices of the sample. An outline of the development of the basic echo-planar imaging equations, including flow, is given. Following their development, for illustrative purposes, the x and y components of B₁ are set equal to zero, B₁ₓ=B_{1y}=0. The starting point for this development is with the definition of transverse magnetization given in terms of a complex coordinate system. This is done to facilitate a computational technique that makes use of Fourier transforms between real- and k-space. The transverse magnetization is thus defined as

M_{T}(t)=Mₓ(t)+iM_{y}(t) (3.1)

where i=\sqrt{−1}.

Meaningful data is obtained when the magnetic spins precess in phase. However, inhomogeneities in the magnetic field tend to de-phase the precessing spins. After the dephasing, an RF pulse, called a re-focussing pulse, is applied. The entire set of spins will begin to re-phase. At a time later, called the echo time, all spins precess with the same phase. The following analysis is based on echo spin detection.

The total transverse magnetization of an excited slice, in which the gradient waveforms are functions of time, t, can be written as

$${M}_{T} ( t ) = \int \int m ( x , y ) exp [ - ⅈ {\int }_{0}^{t} φ ( x , y ; {t}^{′} ) ⅆ {t}^{′} ] ⅆ x ⅆ y , \qquad ( 3.2 )$$

where m(x, y) is the distribution of magnetization over the slice at a time just after excitation. And φ, which is a function, the “phase” function, which maps the time evolution of the transverse magnetization is given by

φ(x, y;t)=γ_{N}[G(r, t)·r(t)] (3.3)

Equation (3.2) assumes implicitly that there is no decay of magnetization due to spin-spin relaxation. For the case of no flow, r is essentially independent of time and the time integration over φ becomes

∫φ(x,y;t′)dt′=kₓx+k_{y}y (3.4)

where

$$\begin{matrix}{k}_{x} = {γ}_{N} {\int }_{0}^{t} {G}_{x} ( {t}^{′} ) ⅆ {t}^{′} , & ( 3.5 ) \\ and & \\ {k}_{y} = {γ}_{N} {\int }_{0}^{t} {G}_{y} ( {t}^{′} ) ⅆ {t}^{′} & ( 3.6 ) \\ then & \\ {M}_{T} ( t ) = \int \int m ( x , y ; t ) exp [ - ⅈ ( {k}_{x} x + {k}_{y} y ) ] ⅆ x ⅆ y = {M}_{T} ( {k}_{x} , {k}_{y} ; t ) & ( 3.7 )\end{matrix}$$

Equation (3.7) is the fundamental equation for MRI. Since it has the form of a two-dimensional Fourier transform an inverse Fourier transform can be defined:

$$m ( x , y ; t ) = \frac{1}{2 π} \int \int {M}_{T} ( {k}_{x} , {k}_{y} ; t ) exp [ ⅈ ( {k}_{x} x + {k}_{y} y ) ] ⅆ {k}_{x} ⅆ {k}_{y} . \qquad ( 3.8 )$$

This transformation yields the required distribution of transverse magnetization for image construction in the selected slice at the time of the measurement. Spin-spin relaxation can now be easily incorporated by letting

M_{T}(k_{X},k_{y};t)→M_{T}(kₓ,k_{y};t)e^{-αk}^{ₓ}e^{-βk}^{_{y}}, (3.9)

where α and β are decay constants inversely proportional to GₓT₂ and G_{Y}T₂, respectively.

The incorporation of blood flow can easily be made by identifying a position point in the blood with r(t). Now r(t) can be expanded in a Taylor series about an arbitrary time coordinate, tₑ. The physical meaningful terms in the expansion are:

$$r ( t ) = r ( {t}_{e} ) + ( t - {t}_{e} ) \frac{ⅆ r ( t )}{ⅆ t} {\vert}_{{t}_{e}} + \frac{1}{2} {( t - {t}_{e} )}^{2} \frac{{ⅆ}^{2} r ( t )}{ⅆ {t}^{2}} {\vert}_{{t}_{e}} + \frac{1}{3 !} {( t - {t}_{e} )}^{3} \frac{{ⅆ}^{3} r ( t )}{ⅆ {t}^{3}} {\vert}_{{t}_{e}} \qquad ( 3.10 )$$

The first derivative corresponds to the velocity of the flow, the second derivative to the acceleration of the flow, and the third derivative to the rate of change of the acceleration of the flow, which would occur in turbulent flow. For illustrative purposes the acceleration is chosen as constant so that Eq. (3.10) reduces to the familiar kinematic equation of basic physics.

$$r ( t ) = r ( {t}_{e} ) + v ( t - {t}_{e} ) + \frac{1}{2} {a ( t - {t}_{e} )}^{2} \qquad ( 3.11 )$$

Substituting Eq. (3.11) into (3.3) and using the definitions of Eqs. (3.5) and (3.6) yields

$$\int φ ( x , y ; {t}^{′} ) ⅆ {t}^{′} \approx k \cdot {r}_{e} + k \cdot v ( t - {t}_{e} ) + \frac{1}{2} k \cdot {a ( t - {t}_{e} )}^{2} . \qquad ( 3.12 )$$

For constant velocity, a=0, the change in the integrated phase is just

ΔΦ≡∫φ(x,y;t′)dt′|_{Flow}−∫φ(x,y;t′)dt′|_{NoFlow}=k·v(t−tₑ). (3.13)

From this, flow parameters can be obtained from the information contained in the differential of the time integrated phase functions. The phase function is part of the general integral definition of the Fourier transform of the transverse magnetization of a slice given by Eq. (3.2).

### Bayesian Parameter Estimation Methods

As a starting point, it is assumed that the MRI measurements result in a set of data that is represented by a column vector D of dimension 1×N. If the data is multi-dimensional it is assume that the pixels, or voxels, can be ordered in such a way as to produce the data vector D, i.e., D(d₁,d₂, . . . , d_{N}). The data D can be modeled by a vector function, f, and n a noise component:

D=f(α)+n, (4.1)

α includes all the physical information, parameters, which arise in constructing a model to represent the data. n represents the system noise, which in general is assumed to be additive and Guassian in form. The model function many be determined from first principles if an adequate physical model of the system is already had, or phenomenologically from the system at hand. Indeed, it may also be determined by a complementary pairing of theoretical and empirical results.

Because of the presence of noise, the inversion of Eq. (4.1) is non-unique and statistical procedures are necessary to obtain information about α. To this end the following probability densities are defined:

P(α|DI)=Probability Density(confidence) that α is true, conditioned on D (4.2a) and any other prior information I.

P(D|αI)=Likelihood Function—Probability Density for the data D to have (4.2b) information concerning α.

P(α|I)=Prior Probability Density on α. (4.2c)

P(D |I)=Probability Density for D. (4.2d)

Note that,

0<P(α|DI)<1, (4.3a)

P(α|DI)=1 implies 100% confidence in α (4.3b)

P(α|DI)=0 implies αis ruled out (4.3c)

An estimation of P(α|DI), also known as the “sampling distribution,” is obtained by using Bayes theorem:

P(α|DI)=[P(D|αI)P(α|I)]/P(D|I) (4.4)

For the case of Gaussian white noise the sampling distribution can be written as

P(D|αI)=ηexp (−[D−f(α)]^{÷}Σ⁻²[D−f(α)]), (4.5)

where η is a normalization constant and Σ is the error covariant matrix for α.

Two methods that have proven fairly successful and that are widely used in the estimation of α are the Maximum Likelihood (ML) method and the Maximum A Posteriori (MAP) method, which are special cases of the Bayesian statistical method.

### Maximum Likelihood (ML) Method

This method corresponds to the case when no prior information is available for the estimation of α . . . Then, the parameter vector α is estimated using

∇αP(D|αI)=0. (4.6)

For Gaussian noise this becomes

∇α[D−f(α)]^{÷}Σ⁻²[D−f(α)]=0. (4.7)

That is Eq. (4.7) corresponds to the minimization of the nonlinear least-squares error. Thus one can use standard least-squares optimization procedures to estimate α.

### Maximum A Posteriori (MAP) Method

In this method it is assumed that a prior estimate for α, αₒ, is available and that the prior probability density is of Gaussian form.

For the special case when both the likelihood and the prior estimate are Gaussian, α can be estimated from the following set of equations:

P(α|DI)=a exp [−(α−αₒ)^{→}σ_{α}⁻²(α−αₒ)], (4.8)

and

χ=[D−f(α)]^{÷}Σ⁻²[D−f(α)]+(α−αₒ)^{÷}σ_{α}⁻²(α−αₒ) (4.9)

∇_{α}χ=0, (4.10)

where a is a normalization constant and σ_{α=δ}₁ⱼΣ, i.e., only the diagonal elements of Σ.

When the noise is taken as Gaussian the MAP method is equivalent to the minimization of χ. Equation (4.10) results in an estimate of αclustered about αₒ. The clustering, or difference, will depend on just how close to the true value(s) αₒ was to begin with. (For the special case of Gaussian noise the MAP method turns out to be equivalent to Ridge Regession.

### Matched Filter Method

The match filter method can generally be stated as the design of an “optimum filter⁺” for the received signal. (The filter is optimized based on the assumed best values of the predetermined filter parameters.) Here it is assumed that a sufficient, but not necessarily accurate, knowledge of the spin-spin relaxation time, T₂, is available so that its affect may be incorporated into the transverse magnetization data via Eq. (3.9):

M_{T}(k_{X},k_{y};t)→M_{T}(kₓ,k_{y};t)e^{-αk}^{ₓ}e^{βk}^{_{y}}, (5.1)

where, again, α and β are decay constants inversely proportional to GₓT₂ and G_{Y}T₂, respectively. The factor of e^{-αk}^{ₓ}e^{βk}^{_{y}} is called the “filter function” in this method. The values αand βare predetermined and fixed in the calculation. A two-dimensional power spectrum, P(kₓ,k_{y};t), may easily be obtained by taking the square of the absolute magnitude of the (complex) transverse magnetization,

P(kₓ,k_{y};t)=>|M_{T}(kₓ,k_{y};t)e^{-αk}^{ₓ}e^{βk}^{_{y}}|². (5.2)

The position of the peaks in the spectrum as a function of time can be used to obtain information about the velocity of the flow.

The matched filter method requires a priori knowledge of the decay constants αand β and the analysis critically depends on the choice of these parameters. In the Bayesian method, previously described, the optimal values of these parameters are determined as part of the calculation. The flexibility of being able to adjust the parameters in accord with the actual test data is a decided advantage over the use of predetermined, fixed parameters employed by current methods in use such as with the matched filter method.

Under certain conditions it is advantageous to use a radially averaged power spectrum, defined by

$${⟨ P ( k ; t ) ⟩}_{θ} = \frac{1}{2 π} {\int }_{0}^{2 π} P ( k , θ ; t ) ⅆ θ , \qquad ( 5.3 )$$

where θ arises through the direction cosines defining kₓ=k Cos (θ) and k_{y}=k Sin(θ) in the plane of the slice on which measurements are being made. Information concerning flow velocity is readily extracted from this procedure as well. Compared to Eq. (5.2), the radially averaged spectrum is simpler to deal with since the number of variables is reduced.

### Bayesian Method

The fundamental equation of MRI given in Eq. (3.7)

M_{T}(k_{X},k_{y};t)=∫∫m(x,y;t) exp [−i(kₓx+k_{y}y)]dxdy. (5.4)

For illustrative purposes it is assumed that the object function, the inverse Fourier transform of Eq. (5.4), takes the form of a multiple Dirac delta function distribution,

m(x,y;t)≈Aδ(x−xₒ)δ(y−yₒ), (5.5)

where

A'm(xₒyₒ;t). (5.6)

For this special case Eq. (5.4) reduces to

M_{T}(kₓ,k_{y};t)≈A exp [−i(kₓxₒ+k_{y}yₒ)]exp (−αkₓ) exp (−βk_{y}), (5.7)

where A, xₒ, yₒ, α and β are the parameters to be estimated. MRI data, D, is then modeled as

D(kₓ,k_{y};t)=M_{T}(kₓ,k_{y};t)+η(kₓ,k_{y}), (5.8)

where η is the noise function and MT is given by Eq. (5.1). An estimation of these parameters follows the general procedures, via Bayesian Probability Theory. The techniques for static imaging can now be applied to Eq. (5.8) for MRI flow imaging. Also, estimation of α and β via the Bayesian approach will return highly probable values and thus an accurate estimate of T₂—which is a characteristic of the patient's system under study. Xₒ and yₒ contain flow velocity information and an accurate estimation of them, via the Bayesian approach, is critical for an evaluation of the patient's condition.

The general formulation of Magnetic Resonance Imaging was constructed with the use of the Bloch equations. The Bloch equations are critical for the analysis because they account for the dephasing of the nuclear magnetic spin system due to spin-spin and spin-lattice interactions. In-phase spin precessional motion is essential to obtain meaningful data—an estimate of the amount of dephasing is a necessity for an accurate interpretation of the data. The effects of spin-lattice and spin-spin interactions were accounted for in the Bloch equations by their associated relaxation, or decay, times, T₁ and T₂, respectively.

Prior art development of MRI was for stationary targets. That development has been extended to incorporate the motion of flowing targets such as blood in a vessel. Typically, the imaging is done in a process called echo-planar imaging in which data is simultaneously taken in multiple slices of the target system. A convenient technique for analyzing the data is to work in reciprocal or Fourier space. Once the transformation was made, the incorporation of flow was made by multiplying the function by exponential functions decaying in Fourier space at a rate proportional to the spin-spin relaxation rate—Eq. (3.9). To complete the picture of flow a kinematic equation describing the motion of a position vector within each slice was derived. This was then related to the “phase” function given as part of the general integral definition of the Fourier transform of the transverse magnetization of a slice given by Eq. (3.2). It was then shown that the differential of the time integrated phase functions, with and with flow included, contains all the necessary flow parameter information.

The Bayesian methodology used for parameter estimation of any problem in which critical parameters are to be extracted from a set of given data was presented. The Bayesian method is unique among all methods, which strive to estimate such parameters in that it is a dynamical method based on conditional probabilities. As a result the parameters can be adjusted for the best fit of the data in real time with minimum uncertainty. Moreover, their values may be improved upon by the addition of a new knowledge of the physical situation in the form of empirical and/or theoretical models that may include features such as boundary conditions or perturbations. This is all accomplished by inputting a model function and the use of conditional probabilities based on Bayes' Theorem. As an illustration, the Bayesian approach was applied to the Method of Maximum Likelihood and the Maximum A Posteriori (MAP) Method.

Lastly, the material was unified and applied to the problem MRI flow parameter estimates. For comparison, an example of the standard technique using matched filters was outlined. Clearly the starting place for both the matched filter method and the Bayesian method was with the same model function, Eq. (5.1). However, the matched filter method requires a priori knowledge of the decay constants α and β and the analysis critically depends on the choice of these parameters. Essentially, the analysis can, and often does, get carried out with only a sufficient, but not necessarily accurate, knowledge of the input parameters—in this case those related to the spin-spin relaxation time.

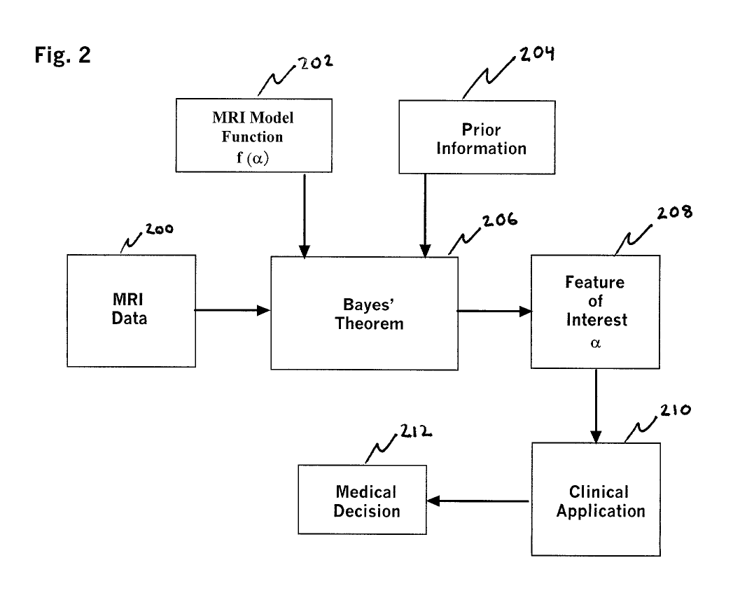

In the Bayesian method the optimal values of the input parameters as well as the parameter of interest are determined as part of the calculation. The input values are used only as an initial guess to start the algorithm. The flexibility of being able to adjust the parameters in accord with the actual experimental data is a decided advantage over the use of predetermined, fixed parameters employed by current methods in use such as with the matched filter method. Moreover, as was pointed out earlier the values of the parameters may be improved upon by the addition of a new knowledge of the physical situation in the form of empirical and/or theoretical models that may include features such as boundary conditions or perturbations. The Bayesian method is a dynamic and unique method for parameter estimation, and prior to this disclosure has not been applied to MRI flow measurements. A summary flow chart of the methodology just described is shown in FIG. 2. MRI data 200, an MRI model function f(α) and prior information 204 are processed utilizing Bayesian methodology 206 to image the feature of interest α. This feature of interest α is utilized in a clinical application 210 to make a medical decision 212.

Unlike traditional methods, which assume an underlying Gaussian noise for the data the Bayesian methods do not assume a specific noise model. Rather the Bayesian method examines the data to infer the relevant noise model appropriate for the problem. It also will compare the probabilities for several noise models and estimate, which noise model one is validated by the data. Thus the Bayesian method can outperform traditional methods in this respect if the underlying noise model is non-Gaussian and nonstationary. In a sense the data speaks for itself through the Bayesian method.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim is reserved.

We claim:

1. A method for flow parameter estimates in magnetic resonance imaging comprising the following steps:
accessing magnetic resonance imaging data;
providing a magnetic resonance imaging model function; and,
using conditional probabilities based on Bayes' Theorem to resolve the magnetic imaging data with respect to the magnetic resonance imaging model.

2. The method as recited in claim 1 further comprising the application of Bayes' Theorem to method of maximum likelihood.

3. The method as recited in claim 1 further comprising the application of Bayes' Theorem to maximum a posteriori (MAP) method.

4. The method as recited in claim 1 further comprising the step of comparing probabilities for at least two noise models and determining which noise model of the at least two noise models is better.

5. The method as recited in claim 4 wherein the magnetic resonance imaging data is examined to determine which noise model of the at least two noise models is better.

6. A system for flow parameter estimates in magnetic resonance imaging comprises:
interface for accessing magnetic resonance imaging data; and
digital processor for using conditional probabilities based on Bayes' Theorem to resolve the magnetic imaging data with respect to a magnetic resonance imaging model.

7. The system as recited in claim 6 wherein the digital processor applies Bayes' Theorem to method of maximum likelihood.

8. The system as recited in claim 6 wherein the digital processor applies Bayes' Theorem to maximum a posteriori (MAP) method.

9. The system as recited in claim 6 wherein the digital processor compares probabilities for at least two noise models and determines which noise model of the at least two noise models is better.

10. The system as recited in claim 9 wherein the magnetic resonance imaging data is examined to determine which noise model of the at least two noise models is better.

11. An improved magnetic resonance imaging device for flow parameter estimates comprises:
a magnetic resonance imaging device having a digital processor;
wherein the digital processor uses conditional probabilities based on Bayes' Theorem to resolve the magnetic imaging data with respect to a magnetic resonance imaging model.

12. The improved magnetic resonance imaging device as recited in claim 11 wherein the digital processor applies Bayes' Theorem to method of maximum likelihood.

13. The improved magnetic resonance imaging device as recited in claim 11 wherein the digital processor applies Bayes' Theorem to maximum a posteriori (MAP) method.

14. The improved magnetic resonance imaging device as recited in claim 11 wherein the digital processor compares probabilities for at least two noise models and determines which noise model of the at least two noise models is better.
